(19) United States
(12) Patent Application Publication
(10) Pub. No.: US 2025/0001382 A1
(43) Pub. Date: Jan. 2, 2025

(54) COMPOSITIONS OF PLANT-BASED FLOUR DELIVERY PARTICLES

(71) Applicant: Encapsys, LLC, Appleton, WI (US)

(72) Inventors: Todd Arlin SCHWANTES, Lena, WI (US); Terri Anne MARQUARDT, Green Bay, WI (US)

(73) Assignee: Encapsys, LLC, Appleton, WI (US)

(21) Appl. No.: 18/754,389

(22) Filed: Jul. 18, 2024

Related U.S. Application Data
(60) Provisional application No. 63/510,720, filed on Jun. 28, 2023.

(51) Int. Cl. B01J 13/16

(52) U.S. Cl. CPC B01J 13/16

(57) ABSTRACT

A population of core/shell delivery particles, where the shell is made, at least in part, of a polymeric material that is the reaction product of a plant-based flour material crosslinking an isocyanate monomer, oligomer, or prepolymer. Related methods of making and using such compositions are described.

### FIELD OF THE INVENTION

The present disclosure relates to a population of core/shell delivery particles, where the shell is made, at least in part, of a plant-based flour material that is characterized by a particular structural polysaccharide content and glycoprotein content. The population of core/shell delivery particles can further be combined with adjunct materials to form slurries of delivery particles. The present disclosure also relates to related methods of making and using such compositions.

### BACKGROUND OF THE INVENTION

Various processes for encapsulation, specifically microencapsulation for forming core/shell delivery particles, and exemplary methods and materials are set forth in Schwantes (U.S. Pat. No. 6,592,990), Nagai et al. (U.S. Pat. No. 4,708,924), Baker et al. (U.S. Pat. No. 4,166,152), Wojciak (U.S. Pat. No. 4,093,556), Matsukawa et al. (U.S. Pat. No. 3,965,033), Matsukawa (U.S. Pat. No. 3,660,304), Ozono (U.S. Pat. No. 4,588,639), Irgarashi et al. (U.S. Pat. No. 4,610,927), Brown et al. (U.S. Pat. No. 4,552,811), Scher (U.S. Pat. No. 4,285,720), Shioi et al. (U.S. Pat. No. 4,601,863), Kiritani et al. (U.S. Pat. No. 3,886,085), Jahns et al. (U.S. Pat. Nos. 5,596,051 and 5,292,835), Matson (U.S. Pat. No. 3,516,941), Chao (U.S. Pat. No. 6,375,872), Foris et al. (U.S. Pat. Nos. 4,001,140; 4,087,376; 4,089,802 and 4,100,103), Greene et al. (U.S. Pat. Nos. 2,800,458; 2,800,457 and 2,730,456), Clark (U.S. Pat. No. 6,531,156), Saeki et al. (U.S. Pat. Nos. 4,251,386 and 4,356,109), Hoshi et al. (U.S. Pat. No. 4,221,710), Hayford (U.S. Pat. No. 4,444,699), Hasler et al. (U.S. Pat. No. 5,105,823), Stevens (U.S. Pat. No. 4,197,346), Riecke (U.S. Pat. No. 4,622,267), Greiner et al. (U.S. Pat. No. 4,547,429), and Tice et al. (U.S. Pat. No. 5,407,609), among others and as taught by Herbig in the chapter entitled “Microencapsulation” in Kirk-Othmer Encyclopedia of Chemical Technology, V.16, pages 438-463.

Delivery particles, particularly core/shell delivery particles, are a convenient way to deliver benefit agents, and can be useful to form aqueous slurries, or dry powder populations of delivery particles, and can be useful in formulating treatment compositions, consumer and industrial products such as for laundry, agriculture, cosmetics and coatings products. For environmental reasons, it may be desirable to use delivery particles that have a wall made from naturally derived and biodegradable materials.

Delivery particles having a shell made at least in part from refined biomaterials are known. However, such particles may not deliver the desired level of performance. Furthermore, many biomaterials have not been successfully adapted to encapsulation due to variability in material, can be expensive to obtain in quantity, or can be a challenging material to work with due to the variability of the materials, poor performance, or other attributes such as viscosity-building tendencies.

There is a need for improved compositions that include delivery particles made from plant-based materials, as well as related methods. A need exists for delivery particles that are sustainable or biodegradable and have improved or comparable properties to synthetic sourced delivery particles, such as having improved deposition or reduced leakage. The invention teaches how to effectively utilize variable plant-based materials in a commercially practical manner and achieve a delivery particle with one or more of the above-described desirable properties such as reduced leakage, improved deposition or biodegradability.

For sustainability reasons plant-based materials are in part desirable. A challenge however is the variability of plant-based materials. Plant-based materials are usually avoided due to complexity attributable to variability of the materials, and refined materials are preferred for simpler material design. Therefore, it is surprising that the invention is able to achieve a functional delivery particle from plant-based materials in native form, such as flours. Plant-based materials in native form would be preferred if able to deliver the same or better or different attributes as compared to refined materials. Isolates of plant-based materials are often difficult to work with, often difficult to dissolve. The invention teaches a population of core-shell delivery particles based on plant-based materials cross-linked with a crosslinker, the delivery particles having reduced leakage, improved deposition or biodegradability.

### SUMMARY OF THE INVENTION

The present disclosure relates to compositions that include plant-based core/shell delivery particles, where the plant-based material used to make the shells is characterized by a particular protein content, structural polysaccharide content and glycoprotein content. The invention describes population of delivery particles, wherein the delivery particles comprise a core and shell surrounding the core, wherein the core comprises a benefit agent, wherein the shell comprises a polyurea derived from a reaction product of an isocyanate and a plant-based flour.

For example, the present disclosure relates to a population of delivery particles, where the delivery particles include a core and shell surrounding the core, where the core includes a benefit agent. The shell includes a polymeric material that is the reaction product of a plant-based material and a cross-linking agent. Disclosed is a population of delivery particles,
wherein the delivery particles comprise a core and shell surrounding the core,
wherein the core comprises a benefit agent,
wherein the shell comprises a polymeric material that is the reaction product of an isocyanate and a plant-based flour, and optionally, from 0 to 5% by weight of an emulsifier,
wherein the plant-based flour is characterized by:
   a) a protein content, of at least 15% by weight of the flour, preferably greater than 25%, more preferably greater than 40%.
   b) a structural polysaccharide content of at least 10% by weight of the flour, preferably greater than 20%
   c) a starch content of less than 50% by weight of the flour, preferably less than 25%, most preferably less than 10% and,
   d) a portion of the protein comprising at least one glycoprotein.

The shell comprises internal and external surfaces, the internal surface of the shell comprising the isocyanate and the external surface of the shell comprising the plant-based flour, the plant-based flour having amine moieties and/or hydroxyl moieties cross-linking with the isocyanate of the internal surface thereby forming the polymeric material of the shell.

The plant-based flour is characterized by comprising at least 47% protein and at least 47% carbohydrate/starch/saccharide, and wherein the plant-based flour is characterized by comprising 5% or less at least 30% by weight of uronic acid. Moreover, the plant-based flour is characterized by being comprised of structural carbohydrates comprising arabinogalactan polysaccharide consisting of arabinose and galactose units in the ratio of 1:0.3 to 1:3 by weight, and uronic acid polysaccharide comprising less than 50%, preferably less than 30% by weight of the plant based flour.

The present disclosure also relates to a method of making such compositions, and articles of manufacture made by combination of the delivery particles with an adjunct material or with a carrier.

Various articles of manufacture can also be made according to the invention by combination of the population of delivery particles with an adjunct or carrier material. Such articles of manufacture can be selected from the group consisting of a soap, a surface cleaner, a fabric care composition such as a laundry detergent or a fabric softener, a shampoo, a textile, a paper towel, an adhesive, a wipe, a diaper, a feminine hygiene product, a facial tissue, a lotion applicator, a pharmaceutical, a napkin, a deodorant, a heat sink, a foam, a pillow, a mattress, bedding, a cushion, a cosmetic, a medical device, packaging, an agricultural product, a pest control product, a cooling fluid, a wallboard, and an insulation. Other articles of manufacture arising from the combination of an adjunct material and the microcapsules can also be fashioned.

### DETAILED DESCRIPTION OF THE INVENTION

The present disclosure relates to delivery particles having shells made, at least in part, from plant-based materials. In particular, the delivery particles include a shell comprising a reaction product of an isocyanate and a plant-based material, in particular a plant-based flour. Significantly, the plant-based material is characterized by selection of a particular proportion of protein, structural polysaccharide, a starch and a portion of the protein constituting glycoprotein. Aspects of the plant-based polysaccharide can also be characterized by a weight average molecular weight that falls within a particular range. A population of core-shell delivery particles based on plant-based materials cross-linked with a crosslinker according to the invention, have one or more advantages of improved particle size distribution, reduced leakage, improved deposition or biodegradability.

Without wishing to be bound by theory, it is believed that careful selection of constituents and of the plant-based flour's molecular weight can be advantageous. For example, selection of a plant-based material having a molecular weight above a certain threshold can surprisingly result in delivery particles that function better at certain touchpoints compared to delivery particles made from plant-based material of different composition or of a lower molecular weight. Furthermore, selection of plant-based characterized by a relatively high molecular weight can result in processing challenges, as such plant-based tends to build viscosity, particularly in aqueous environments; the relatively high viscosity can affect the convenient flowability of such solutions and/or inhibit the adequate formation of particle walls.

The plant-based, delivery particle compositions, and related methods of the present disclosure are discussed in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

As used herein “flour” is the milled or ground cereal grain or starchy portions of plants. Flour can comprise milled or ground grains, roots, beans, nuts, and seeds of plants. For illustration, flour includes milled or ground up soybeans, wheat, rye, corn, barley, rice, sorghum, pea, lentil, chickpea and the like. Often these plant materials, such as soy are defatted, dehulled and milled or otherwise ground to form powdery material. Certain plant-based flours are compositionally suitable in terms of protein content, structural polysaccharide content, starch content and glycoprotein content for formation of the delivery particles of the invention. Suitable plant-based flours that can meet the criteria of protein content, structural polysaccharide content, starch content and glycoprotein content were found to comprise soybean, pea, lentil, and chickpea flours. Other plant-based flours can be useful provided selected according to the invention to meet the required compositional criteria described herein of protein content, structural polysaccharide content, starch content and glycoprotein content.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein “consumer product,” means baby care, beauty care, fabric & home care, family care, feminine care, and/or health care products or devices intended to be used or consumed in the form in which it is sold, and not intended for subsequent commercial manufacture or modification. Such products include but are not limited to diapers, bibs, wipes; products for and/or methods relating to treating human hair, including bleaching, coloring, dyeing, conditioning, shampooing, styling; deodorants and antiperspirants; personal cleansing; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; adult incontinence products; products and/or methods relating to oral care including toothpastes, tooth gels, tooth rinses, denture adhesives, tooth whitening; over-the-counter health care including cough and cold remedies; pest control products; and water purification. Consumer products are fashioned by combination of the population of delivery particles as taught herein with one or more adjuvant materials.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation. Fabric care compositions are fashioned by combination of the population of delivery particles as taught herein with one or more adjuvant materials.

As used herein, “delivery particles,” “particles,” “core-shell delivery particles,” “encapsulates,” “microcapsules,” “core-shell microcapsules,” and “capsules” are used interchangeably, unless indicated otherwise. As used herein, these terms typically refer to core/shell delivery particles.

For ease of reference in this specification and in the claims, the term “monomer” or “monomers” as used herein with regard to the materials that form the wall polymer of the delivery particles is to be understood as monomers, but also is inclusive of oligomers and/or prepolymers formed of the specific monomers.

As used herein the term “water soluble material” means a material that has a solubility of at least 0.5% wt in water at 60° C.

As used herein the term “oil soluble” means a material that has a solubility of at least 0.1% wt in the core of interest at 50° C.

As used herein the term “oil dispersible” means a material that can be dispersed at least 0.1% wt in the core of interest at 50° C. without visible agglomerates.

For clarity, when referring to structural polysaccharides, structural polysaccharides are to be understood as referring to the major polysaccharide found in plants responsible for a structural role. Structural polysaccharides include cellulose, bemicellulose, xylans, mannans, glucomannans, galactans, araboglactans, pectic substances, galactan, arabinan, and galacturonan.

Storage polysaccharides comprise i) low molecular weight sugars both mono- and di-saccharides; ii) oligosaccharides, and iii) polysaccharides such as starch. Starch is a combination of amylose and amylopectin. Storage polysaccharides are considered non-structural polysaccharides. Polysaccharides can include homo-polysaccharides and hetero-polysaccharides. Homo-polysaccharides have one type of monosaccharide repeating in the chain, whereas hetero-polysaccharides are composed of two or more types of monosaccharides. Unbranched polysaccharides contain alpha 1,4 linkages. Branched polysaccharides can be branched between sugar residues via alpha 1,4 or alpha 1,6 glycosidic bonds. Storage polysaccharides can include starch, inulin, pectin,

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (C) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Benefit Agent Delivery Particles

The present disclosure relates to benefit agent delivery particles. The benefit agent delivery particles can be used neat, or as a liquid slurry, as dry particles, as a combination with an adjunct, as an agglomerate, as spray-dried particles, or in combination with additional adjunct materials.

A novel population of delivery particles is disclosed. The delivery particles comprise a core and shell surrounding the core, wherein the core comprises a benefit agent; the shell comprises a polymeric material that is the reaction product of plant-based material, namely a flour, preferably a milled flour, and a cross-linking agent. The plant-based material is characterized by a protein content, of at least 15% by weight flour, preferably greater than 25%, more preferably greater than 40%; a structural polysaccharide content of at least 10% by weight of the flour, preferably greater than 20%; a starch content of less than 50% by weight of the flour, preferably less than 25%, most preferably less than 10%, and, a portion of the protein comprising at least one glycoprotein.

The plant-based flour structural polysaccharides are characterized by a weight average molecular weight greater than 1000 kilodaltons (“kDa”), preferably from about 5000 kDa to about 35000 kDa.

The plant-based flour is characterized by a nitrogen content of from about 2.5 to 10%, preferably 5 to 10%, or even 8.4 to 8.8% by weight, preferably about 8.6%.

The invention describes a population of delivery particles,
wherein the delivery particles comprise a core and shell surrounding the core,
   wherein the core comprises a benefit agent,
   wherein the shell comprises a polymeric material that is the reaction product of an isocyanate and a plant-based flour, and optionally, from 0 to 5% by weight of an emulsifier, preferably 0%.
   wherein the plant-based flour is characterized by:
      a) a protein content, of at least 15% by weight of the flour, preferably greater than 25%, more preferably greater than 40%.
      b) a structural polysaccharide content of at least 10% by weight of the flour, preferably at least 20% or greater than 20%
      c) a starch content of less than 50% by weight of the flour, preferably less than 25%, most preferably less than 10% and,
      d) a portion of the protein comprising at least one glycoprotein.

Glycoproteins are a sub-class of proteins which have carbohydrate groups attached to the polypeptide chain, and for purposes herein are inclusive of glycopeptides. More particularly, glycoproteins are proteins containing glycans attached to amino acid side chains. Glycans are oligosaccharide chains, that can attach to either lipids (glycolipids) or to amino acids (forming glycoproteins). The oligosaccharide chains are covalently attached to the amino acid side-chains typically through glycosylation (N, O, P, C or S type, depending on the respective atom to which the saccharide attaches. Other processes of attachment can include glypiation where glycolipid attaches to the C-terminus of a polypeptide, or glycation where the saccharides bond to protein or lipid in the absence of an enzyme mediated reaction.

For example, N-glycosylation sugars attach to nitrogen, typically on an amide side chain.

Water extracts of flours typically separate proteins and starches, which results in removal or reduction of glycoproteins of flour such as soy or wheat, from the flour. Glycoprotein fractions can contain pentosans, ferulic acid, and additional materials. Glycoproteins are a beneficial component for certain characteristics of flours, but glycoproteins typically are absent from refined fractions of proteins and starches or at practically non-detect levels (<0.0001 wt % of the weight of the flour). Core-shell delivery particles based on the use of such plant-based materials in combination with isocyanate are improved in encapsulation efficiency, have reduced leakage, improved deposition and/or biodegradability.

In contrast to milled grains, refined proteins and refined saccharides derived from flours often lose the water-soluble glycoprotein content. The absence of glycoprotein in refined saccharides and proteins surprisingly leads to differing encapsulation characteristics of encapsulates based on flours as compared to reconstituted saccharide and protein combinations. Native flours are unique in containing glycoprotein, and combinations of glycoprotein, absent in reconstituted protein and refined starch or saccharide re-combinations.

In flours in the invention, the flour contains glycoprotein. The glycoprotein fraction comprises less than 5 wt % or even less than 1 wt % or even less than 0.5 wt %, or even less than 0.1 wt % of the weight of the flour.

Diverse functional groups present in proteins include amines, amides, thiols, alcohols, and carboxylic acids, and present a large number of potential reaction sites for isocyanate. Isocyanates can react with water to form amines, can react with polyols and hydroxy groups to form urethanes, can further react with amines to form ureas, and can react with carboxylic acids to form amides. In the encapsulates of the invention an isocyanate-based shell of the core-shell microcapsules is further reacted with flour acting as a crosslinker. The flour is comprised of a) protein content, of at least 15% by weight of the flour, preferably greater than 25%, more preferably greater than 40%; b) a structural polysaccharide content of at least 10% by weight of the flour, preferably greater than 20%; c) a starch content of less than 50% by weight of the flour, preferably less than 25%, most preferably less than 10% and, d) and a portion of the protein comprising at least one glycoprotein.

The carbohydrate in glycoprotein is an oligosaccharide chain (glycan) covalently bonded to peptide side chains of protein. Because of the —OH groups of sugars, glycoproteins are more hydrophilic than simple proteins due to hydroxy groups of the carbohydrate sugars. Glycoproteins have higher affinity to water than ordinary proteins.

The carbohydrate of glycoprotein typically comprises one or more simple sugars such as glucose, galactose, mannose, xylose; amino sugars (sugars that have an amino group, such as N-acetylglucosamine or N-acetylgalactosamin; and acidic sugars (sugars that have a carboxyl group, such as sialic acid or N-acetylneuraminic acid).

Refining of flours by common fractionating into protein and starches results in removal or glycoprotein reduction to non-detect levels, <0.0001 wt %.

Water-soluble glycoproteins typically comprise low-molecular weight glycoproteins containing galactose and mannose. Higher-molecular weight glycoprotein fractions typically can contain galactose, glucose, mannose, xylose, and rhamnose.

In the flours useful to form the shell, glycoprotein is present at 0.001 wt % or more, or even 0.01 wt % or more, or preferably even from 0.01 wt to 5 wt %, or more preferably even from 0.01 to 3 wt %.

In embodiments, the plant-based flour is characterized by at least one, preferably at least three, more preferably all four, of the following: a protein content, of at least 15% by weight of the flour, preferably greater than 25%, more preferably greater than 40%. a structural polysaccharide content of at least 10% by weight of the flour, preferably greater than 20% a starch content of less than 50% by weight of the flour, preferably less than 25%, most preferably less than 10%, and, a portion of the protein comprising at least one glycoprotein In embodiments, the plant-based can be a plant-based material, selected from milled vegetable flour, unrefined vegetable flour, soy flour, defatted soybean meal, dehulled soybean meal, faba bean flour, chickpea flour, yellow pea flour, lentil flour.

In embodiments, core-shell encapsulates according to the invention have free core levels near 1% beneficial agent such as in encapsulation of fragrance cores. Embodiments have release profiles useful in diverse applications. In agricultural applications it is useful to tailor the release profile such as ranging from under 50% release after 15 minutes of extraction in water or in matrix solution or carrier material, to 100% release after 180 minutes of extraction in water or in matrix solution or carrier material. In fragrance applications, a release profile exhibiting low free oil is often desired.

The isocyanate is a cross-linking agent reactive with the plant-based flour. The plant-based flour preferably is a native flour, but in additional embodiments, can be a treated plant-based flour, an anionically modified plant-based flour, a cationically modified plant-based flour, or mixtures thereof.

The shell of the core-shell encapsulate is a reaction product of isocyanate and the plant-based flour. The term “isocyanate” is to be understood for purposes hereof to include monomers, oligomers, and prepolymers thereof. As used herein the term “isocyanate” is used interchangeably with the term “polyisocyanate” or “poly-isocyanate” and refers to such materials having two or more isocyanate groups, i.e., —N═C═O. Although mono-isocyanates may be used in combination with the herein recited required isocyanates, the isocyanates required herein have at least two isocyanate groups. As noted, the isocyanate component comprises di- and/or poly-isocyanate. Preferably the isocyanate useful herein is selected from the group consisting of a polyisocyanurate of toluene diisocyanate, a trimethylol propane adduct of toluene diisocyanate, a trimethylol propane adduct of xylylene diisocyanate, methylene diphenyl diisocyanate, toluene diisocyanate, tetramethylxylidene diisocyanate, naphthalene-1,5-diisocyanate, phenylene diisocyanate and combinations thereof. This listing is illustrative and not intended to be limiting.

The cross-linking agent reactive with isocyanate is the plant-based material, namely the flour, preferably a soy flour.

In the population of delivery particles, the shell is a reaction product, wherein the weight ratio of the plant-based flour for crosslinking the isocyanate (ratio of plant-based flour to isocyanate) in the reaction (and reaction product) is from about 1:10 to about 1:0.1.

The benefit agent preferably is a fragrance material or agriculture active ingredient.

The core of the population of core/shell delivery particles can further comprise a partitioning modifier, optionally present in the core at a level of from about 5% to about 55%, preferably from about 10% to about 50%, more preferably from about 25% to about 50%, by weight of the core, preferably a partitioning modifier selected from the group consisting of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof, and more preferably isopropyl myristate.

The delivery particles are characterized by a volume-weighted median particle size from about 1 to about 100 microns, from about 1 to about 50 microns, or preferably from about 1 to about 25 microns, or even from about 1 to about 10 microns, from about 15 to about 50 microns, from about 20 to about 40 microns, or even from about 2 to about 35 microns, or even from about 10 to about 30 microns.

The delivery particles are obtainable from a process comprising the steps of:
forming a water phase by dissolving or dispersing a plant-based flour into an aqueous solution;
forming an oil phase comprising dissolving together at least one benefit agent and at least one polyisocyanate, optionally with an added oil, optionally with a partitioning modifier;
forming an emulsion by mixing under high shear agitation the water phase and the oil phase into an excess of the water phase, thereby forming droplets of the benefit agent and optional added oil dispersed in the water phase, and optionally adjusting the pH of the emulsion to be in a range from 6-12 or even in the range from pH 7 to pH 10, curing the emulsion by heating to at least 40° C., for a time sufficient to form a shell at an interface of the droplets with the water phase, the shell comprising the reaction product of the plant-based flour and the polyisocyanate, the shell surrounding the core comprising the droplets of the oil phase and benefit agent. The oil phase comprises the benefit agent, or the benefit agent dissolved in an oil. It should be understood that in certain applications the benefit agent itself can be an oil such as an oil fragrance, and therefore can itself constitute the oil phase. Optionally the benefit agent is dissolved or dispersed in an oil, and the core comprises the benefit agent dissolved in the oil.

Embodiments of the population of delivery particles according to the invention, have shells wherein the shells of the delivery particles degrade at least 30% in 30 days, or even at least 30% in 60 days, or even at least 60% in 60 days, when tested according to test method OECD 301B.

Additional components and/or features of the compositions are discussed in more detail below.

### Population of Delivery Particles

The compositions of the present disclosure comprise a population of delivery particles. The delivery particles comprise a core and a shell surrounding the core. The core may comprise a benefit agent, and optionally a partitioning modifier. The core can be a liquid or a solid, preferably a liquid, at room temperature.

The composition may comprise from about 0.05% to about 20%, or from about 0.05% to about 10%, or from about 0.1% to about 5%, or from about 0.2% to about 2%, by weight of the composition, of delivery particles. The composition may comprise a sufficient amount of delivery particles to provide from about 0.05% to about 10%, or from about 0.1% to about 5%, or from about 0.1% to about 2%, by weight of the composition, of the encapsulated benefit agent, which may preferably be perfume raw materials, to the composition. The balance of the composition can be a water carrier, such as in the case of an aqueous slurry, or a binder material, such as in the case of an agglomerated spray-dried product or can be one or more adjunct materials as more fully described herein. In embodiments, optionally the population of delivery particles can be dried delivery particles without need for adjunct material. When discussing herein the amount or weight percentage of the delivery particles, it is meant the sum of the wall material and the core material.

The population of delivery particles according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 25 to about 35 microns. For certain compositions, it may be preferred that the population of delivery particles is characterized by a volume-weighted median particle size from about 1 to about 50 microns, preferably from about 5 to about 20 microns, more preferably from about 10 to about 15 microns. Different particle sizes are obtainable by controlling droplet size during emulsification.

The delivery particles may be characterized by a ratio of core to shell up to 99:1, or even 99.5:0.5, on the basis of weight. The shell may be present at a level of from about 1% to about 25%, preferably from about 1% to about 20%, preferably from about 1% to 15%, more preferably from about 5% to about 15%, even more preferably from about 10% to about 15%, even more preferably from about 10% to about 12%, by weight of the delivery particle. The shell may be present at a level of least 1%, preferably at least 3%, more preferably at least 5% by weight of the delivery particle. The shell may be present at a level of up to about 25%, preferably up to about 15%, more preferably up to about 12%, by weight of the delivery particle.

The delivery particles may be cationic in nature, preferably cationic at a pH of 4.5. The delivery particles may be characterized by a zeta potential of at least 15 millivolts (mV) at a pH of 4.5. The delivery particles can be fashioned to have a zeta potential of at least 15 millivolts (mV) at a pH of 4.5, or even at least 40 mV at a pH of 4.5, or even at least 60 mV at a pH of 4.5. Polyurea capsules prepared with plant-based materials typically exhibit positive zeta potentials. Such capsules have improved deposition efficiency on fabrics. At higher pH, the particles may be able to be made nonionic or anionic.

The delivery particles of the present disclosure comprise a shell surrounding a core. (As used herein, “shell” and “wall” are used interchangeably with regard to the delivery particles, unless indicated otherwise.) The shell comprises a polymeric material. The polymeric material is the reaction product of plant-based flour and a cross-linking agent.

As described above, the plant-based flour is preferably characterized by a particular weight average molecular weight. Without wishing to be bound by theory, it is believed that careful selection of the molecular weight of the plant-based flour used to form the shell of the delivery particles results in better performing particles and/or processing convenience.

The plant-based flour may be characterized by a weight average molecular weight of from about 100 kDa to about 600 kDa. Preferably, the plant-based flour is characterized by a weight average molecular weight (Mw) of from about 100 kDa to about 500 kDa, preferably from about 100 kDa to about 400 kDa, more preferably from about 100 kDa to about 300 kDa, even more preferably from about 100 kDa to about 200 kDa. To determine the plant-based flour's molecular weight gel permeation chromatography with light scatter detection techniques can be used, such as described in S. Podzimek. The use of GPC coupled with a multiangle laser light scattering photometer for the characterization of polymers. On the determination of molecular weight, size, and branching. J. Appl. Polymer Sci. 1994 54, 91-103

The plant-based flour may comprise anionically modified plant-based flour, cationically modified plant-based flour, or a combination thereof. Modifying the plant-based flour in an anionic and/or cationic fashion can change the character of the shell of the delivery particle, for example, by changing the surface charge and/or zeta potential, which can affect the deposition efficiency and/or formulation compatibility of the particles.

As mentioned above, the shell is a polymeric material that is the reaction product of the plant-based flour and a cross-linking agent. Preferably, the cross-linking agent comprises a polyisocyanate. Thus, the shell of the delivery particles may comprise a polyurea resin, wherein the polyurea resin comprises the reaction product of a polyisocyanate and a plant-based flour.

The shell of the core-shell encapsulate is a reaction product of isocyanate. Isocyanate to be understood for purposes hereof as di- or poly-isocyanates, and intended to encompass monomers, oligomers, and prepolymers thereof. The term “isocyanate” is used interchangeably with the term “polyisocyanate” and/or “poly-isocyanate” and refers to such materials having two or more isocyanate groups, i.e., —N═C═O. generally referred to as polyisocyanate. Isocyanates with two isocyanate groups being referred as di- and isocyanates with more than two isocyanate groups being referred to as poly-isocyanates, respectively. The isocyanate component useful in the present disclosure is to understood as including isocyanate monomer, isocyanate oligomer, isocyanate prepolymer, or dimer or trimer of an aliphatic or aromatic isocyanate. Generally such isocyanates are di- and/or poly-isocyanates. Although mono-isocyanates can be used in combination, isocyanate that is poly-isocyanate with two or more isocyanate groups is required. The poly-isocyanates useful in the present disclosure encompass isocyanate monomers, oligomers or prepolymers, or dimers or trimers thereof, have at least two isocyanate groups. Preferred cross-linking can be achieved with polyisocyanates having at least three functional groups.

Aromatic polyisocyanates may be preferred; however, aliphatic polyisocyanates and blends thereof may be useful. Aliphatic polyisocyanate is understood as a polyisocyanate which does not comprise any aromatic moiety. The isocyanate herein may comprise a mixture of an aromatic polyisocyanate and an aliphatic polyisocyanate.

The cross-linking agent can be selected from the group consisting of a polyisocyanurate of toluene diisocyanate, a trimethylol propane adduct of toluene diisocyanate, a trimethylol propane adduct of xylylene diisocyanate, methylene diphenyl diisocyanate, toluene diisocyanate, tetramethylxylidene diisocyanate, naphthalene-1,5-diisocyanate, phenylene diisocyanate, 2,2′-methylenediphenyl diisocyanate, 4,4′-methylenediphenyl diisocyanate, 2,4′-methylenediphenyl diisocyanate, toluene diisocyanate, tetramethylxylidene diisocyanate, naphthalene-1,5-diisocyanate, 1,4-phenylene diisocyanate, 1,3-diisocyanatobenzene and combinations thereof.

The particle shell may also be reinforced using additional co-crosslinkers such as multifunctional amines and/or polyamines, such as diethylene triamine (DETA), polyethylene imine, polyvinyl amine, or mixtures thereof.

The polymeric material may be formed in a reaction, where the weight ratio of the plant-based flour present in the reaction to the isocyanate present in the reaction is from about 1:10 to about 1:0.1. It is believed that selecting desirable ratios of the biopolymer to the isocyanate can provide desired benefits, such as improved biodegradability. It may be preferred that at least 21 wt % of the shell is comprised of moieties derived from plant-based flour. Plant-based flour as a percentage by weight of the shell may be from about 21% up to about 95% of the shell. The ratio of plant-based flour in the water phase as compared to the isocyanate in the oil phase may be, based on weight, from 21:79 to 90:10, or even from 1:2 to 8:1, or even from 1:1 to 7:1. The polymeric material may be formed in a reaction, where the weight ratio of the plant-based flour or even a derivative thereof (which can include for example acid-treated plant-based flour) present in the reaction to the cross-linker present in the reaction is from about 1:10 to about 10:1, preferably from about 1:5 to about 5:1, preferably from about 1:4 to about 5:1, more preferably from about 1:1 to about 5:1, more preferably from about 3:1 to about 5:1. The shell may comprise plant-based flour at a level of 21 wt % or even greater, preferably from about 21 wt % to about 90 wt %, or even from 21 wt % to 85 wt %, or even 21 wt % to 75 wt %, or 21 wt % to 55 wt % of the total shell being plant-based.

The population of delivery particles may be made according to a process that comprises the following steps: (a) forming a water phase that includes plant-based flour as described herein, preferably where the water phase is at a pH of 6.5 or less, more preferably at a pH of from 3 to 6, and a temperature of at least 25° C.; (b) forming an oil phase that comprises at least one benefit agent, preferably fragrance material, and at least cross-linking agent, preferably at one polyisocyanate, and optionally a partitioning modifier; (c) forming an emulsion, preferably an oil-in-water emulsion, by mixing the water phase and the oil phase under high shear agitation, optionally adjusting the pH of the emulsion to be in a range of from pH 2 to pH 6; (d) curing the emulsion by heating, preferably to at least 40° C., for a time sufficient to form a shell at the interface of the oil droplets with the water phase, where the shell will comprise a polymeric material that is the reaction product of the plant-based flour and the cross-linking agent, and where the shell surrounds a core that comprises the benefit agent.

In embodiments, the population of delivery particles may be made according to a process that comprises the following steps: (a) forming a water phase by dissolving or dispersing a plant-based flour in water at a temperature of at least 25° C.; (b) forming an oil phase comprising dissolving together at least one benefit agent and at least one polyisocyanate, optionally with an added oil (e.g., partitioning modifier) and/or solvent; (c) forming an emulsion by mixing under high shear agitation the water phase and the oil phase into an excess of the water phase, thereby forming droplets of the benefit agent and optional added oil dispersed in the water phase; (d) curing the emulsion by heating to at least 40° C., for a time sufficient to form a shell at an interface of the droplets with the water phase, the shell comprising the reaction product of the polyisocyanate and the plant-based flour, and the shell surrounding the core comprising the droplets of the benefit agent and optional added oil.

The shell may degrade at least 50% after 20 days (or less) when tested according to test method OECD 301B. The shell may degrade at least 60% of its mass after 60 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

The delivery particles of the present disclosure include a core. The core comprises a benefit agent. The core optionally comprises a partitioning modifier.

The core of a particle is surrounded by the shell. When the shell is ruptured, the benefit agent in the core is released. Additionally or alternatively, the benefit agent in the core may diffuse out of the particle, and/or it may be squeezed out. Suitable benefit agents located in the core may include benefit agents that provide benefits to a surface, such as a fabric or hair, or to other surfaces or targets.

The core may comprise from about 5% to about 100%, by weight of the core, of a benefit agent, which may preferably comprise a fragrance. The core may comprise from about 45% to about 95%, preferably from about 50% to about 80%, more preferably from about 50% to about 70%, by weight of the core, of the benefit agent, which may preferably comprise a fragrance.

The benefit agent may be a hydrophobic benefit agent. Such agents are compatible with the oil phases that are common in making the delivery particles of the present disclosure.

The benefit agent is selected so as to provide a benefit under preferred uses of the composition. The benefit agent of the core-shell microcapsules can be selected from a fragrance, chromogen, an agricultural active, a phase change material and other actives as described herein. More particularly, for illustration and not by way of limitation, the benefit agent in the core may be selected from fragrance materials, chromogens and dyes, flavorants, perfumes, sweeteners, oils, fats, pigments, cleaning oils, pharmaceuticals, pharmaceutical oils, essential oils, mold inhibitors, antimicrobial agents, adhesives, phase change materials, scents, fertilizers, nutrients, and herbicides, silicone oils, waxes, hydrocarbons, higher fatty acids, essential oils, lubricants, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, synthetic or natural actives, antibacterial actives, antiperspirant actives, cationic polymers, dyes, and mixtures thereof.

The core can be a liquid or a solid. With cores that are solid at ambient temperatures, the wall material can usefully enwrap less than the entire core for certain applications where availability of, for example, an agglomerate core is desired on application. Such uses can include scent release, cleaning compositions, emollients, cosmetic delivery, agricultural delivery, and the like. Where the microcapsule core is phase change material, uses can include such encapsulated materials in mattresses, pillows, bedding, textiles, sporting equipment, medical devices, building products, construction products, HVAC, renewable energy, clothing, athletic surfaces, electronics, automotive, aviation, shoes, beauty care, laundry, and solar energy.

The benefit agent in the core preferably, in a preferred embodiment, comprises fragrance material (or simply “fragrance”), which may include one or more perfume raw materials. Fragrance is particularly suitable for encapsulation in the presently described delivery particles, as the fragrance-containing particles can provide freshness benefits across multiple touchpoints.

The term “perfume raw material” (or “PRM”) as used herein refers to compounds having a molecular weight of at least about 100 g/mol and which are useful in imparting an odor, fragrance, essence or scent, either alone or with other perfume raw materials. Typical PRMs comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackic Academic and Professional (1994).

The PRMs may be characterized by their boiling points (B.P.) measured at the normal pressure (760 mm Hg), and their octanol/water partitioning coefficient (P), which may be described in terms of log P, determined according to the test method below. Based on these characteristics, the PRMs may be categorized as Quadrant I, Quadrant II, Quadrant III, or Quadrant IV perfumes, as described in more detail in U.S. Pat. No. 6,869,923. Suitable Quadrant I, II, III, and IV perfume raw materials are disclosed therein.

Perfume raw materials having a boiling point B.P. lower than about 250° C. and a log P lower than about 3 are known as Quadrant I perfume raw materials. Quadrant I perfume raw materials are preferably limited to less than 30% of the fragrance material.

The fragrance may comprise perfume raw materials that have a log P of from about 2.5 to about 4. It is understood that other perfume raw materials may also be present in the fragrance.

The core of the delivery particles of the present disclosure may comprise a partitioning modifier, which may facilitate more robust shell formation. The partitioning modifier may be combined with the core's perfume oil material prior to incorporation of the wall-forming monomers. The partitioning modifier may be present in the core at a level of from 0% to 95%, preferably from about 5% to about 55%, preferably from about 10% to about 50%, more preferably from about 20% to about 50%, even more preferably from about 25% to about 50%, by weight of the core.

The partitioning modifier may comprise a material selected from the group consisting of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof. The partitioning modifier may preferably comprise or even consist of isopropyl myristate. The modified vegetable oil may be esterified and/or brominated. The modified vegetable oil may preferably comprise castor oil and/or soybean oil. US Patent Application Publication 20110268802, incorporated herein by reference, describes other partitioning modifiers that may be useful in the presently described delivery particles.

Where the benefit agent is not itself sufficient to serve as the oil phase or solvent, particularly during the process of forming the shell of the delivery particles for the wall forming materials, the oil phase can comprise a suitable carrier and/or solvent. In this sense, the oil is optional, as the benefit agent itself can at times be the oil. These carriers or solvents are generally an oil, preferably have a boiling point greater than about 80° C. and low volatility and are non-flammable. Though not limited thereto, they preferably comprise one or more esters, preferably with chain lengths of up to 18 carbon atoms or even up to 42 carbon atoms and/or triglycerides such as the esters of C6 to C12 fatty acids and glycerol.

Optionally, the water phase may include an emulsifier. Non-limiting examples of emulsifiers include anionic surfactants (such as alkyl sulfates, alkyl ether sulfates, and/or alkyl benzenesulfonates), nonionic surfactants (such as alkoxylated alcohols, preferably comprising ethoxy groups), polyvinyl alcohol, and/or polyvinyl pyrrolidone. It may be that solubilized plant-based flour can provide emulsifying benefits in the present applications. Emulsifier, if employed, is typically from about 0.1 to 40% by weight, preferably 0.2 to about 15% by weight, more typically 0.5 to 10% by weight, based on total weight of the aqueous phase.

The population of delivery particles may be provided as a slurry, preferably an aqueous slurry. The slurry can include one or more processing aids, which may include water, aggregate inhibiting materials such as divalent salts, or particle suspending polymers such as xanthan gum, guar gum, cellulose (preferably microfibrillated cellulose) and/or carboxy methyl cellulose. When the delivery particles are characterized by a cationic nature (for example, when the shell is derived, at least in part, from plant-based flour), a non-anionic structurant, preferably a nonionic structurant, may be preferred, for example, to avoid detrimental charge interactions that may lead to undesirable aggregation.

The slurry can include one or more carriers selected from the group consisting of polar solvents, including but not limited to, water, ethylene glycol, propylene glycol, polyethylene glycol, glycerol; nonpolar solvents, including but not limited to, mineral oil, perfume raw materials, silicone oils, hydrocarbon paraffin oils; and mixtures thereof. Aqueous slurries may be preferred. The slurry may comprise non-encapsulated (of “free”) perfume raw materials that are different in identity and/or amount from those that are encapsulated in the cores of the delivery particles.

The slurry may include a deposition aid that may comprise a polymer selected from the group comprising: polysaccharides, such as plant-based, cationically modified starch and/or cationically modified guar; polysiloxanes; poly diallyl dimethyl ammonium halides; copolymers of poly diallyl dimethyl ammonium chloride and polyvinyl pyrrolidone; a composition comprising polyethylene glycol and polyvinyl pyrrolidone; acrylamides; imidazoles; imidazolinium halides; polyvinyl amine; copolymers of poly vinyl amine and N-vinyl formamide; polyvinyl formamide, polyvinyl alcohol; polyvinyl alcohol crosslinked with boric acid; polyacrylic acid; polyglycerol ether silicone cross-polymers; polyacrylic acids, polyacrylates, copolymers of polyvinylamine and polvyinylalcohol oligomers of amines, in one aspect a diethylenetriamine, ethylene diamine, bis(3-aminopropyl) piperazine, N,N-Bis-(3-aminopropyl)methylamine, tris(2-aminoethyl)amine and mixtures thereof; polyethyleneimine, a derivatized polyethyleneimine, in one aspect an ethoxylated polyethyleneimine; a polymeric compound comprising, at least two moieties selected from the moieties consisting of a carboxylic acid moiety, an amine moiety, a hydroxyl moiety, and a nitrile moiety on a backbone of polybutadiene, polyisoprene, polybutadiene/styrene, polybutadiene/acrylonitrile, carboxyl-terminated polybutadiene/acrylonitrile or combinations thereof; pre-formed coacervates of anionic surfactants combined with cationic polymers; polyamines and mixtures thereof.

At least one population of delivery particles may be contained in an agglomerate and then combined with a distinct population of delivery particles and at least one adjunct material. Said agglomerate may comprise materials selected from the group consisting of silicas, citric acid, sodium carbonate, sodium sulfate, sodium chloride, and binders such as sodium silicates, modified celluloses, polyethylene glycols, polyacrylates, polyacrylic acids, zeolites and mixtures thereof.

Suitable equipment for use in the processes disclosed herein may include continuous stirred tank reactors, homogenizers, turbine agitators, recirculating pumps, paddle mixers, plough shear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., U.S.A.), Arde Barinco (New Jersey, U.S.A.).

### Adjunct Ingredient

The compositions of the present disclosure may comprise one or more adjunct materials in addition to the delivery particles. The adjunct material may provide a benefit in the intended end-use of a composition, or it may be a processing and/or stability aid.

Suitable adjunct materials may include: surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, anti-agglomeration agents, coatings, formaldehyde scavengers, and/or pigments. Preferably, the adjunct materials comprise additional fabric conditioning agents, dyes, pH control agents, solvents, rheology modifiers, structurants, cationic polymers, surfactants, perfume, additional perfume delivery systems, chelants, antioxidants, preservatives, or mixtures thereof.

The precise nature of these additional components, and levels of incorporation thereof, will depend on the physical form of the composition and the nature of the operation for which it is to be used. However, when one or more adjuncts are present, such one or more adjuncts may be present as detailed below. The following is a non-limiting list of suitable additional adjuncts.

### A. Surfactants

The compositions of the present disclosure may comprise surfactant. Surfactants may be useful for providing, for example, cleaning benefits. The compositions may comprise a surfactant system, which may contain one or more surfactants.

The compositions of the present disclosure may include from about 0.1% to about 70%, or from about 2% to about 60%, or from about 5% to about 50%, by weight of the composition, of a surfactant system. Liquid compositions may include from about 5% to about 40%, by weight of the composition, of a surfactant system. Compact formulations, including compact liquids, gels, and/or compositions suitable for a unit dose form, may include from about 25% to about 70%, or from about 30% to about 50%, by weight of the composition, of a surfactant system.

The surfactant system may include anionic surfactant, nonionic surfactant, zwitterionic surfactant, cationic surfactant, amphoteric surfactant, or combinations thereof. The surfactant system may include linear alkyl benzene sulfonate, alkyl ethoxylated sulfate, alkyl sulfate, nonionic surfactant such as ethoxylated alcohol, amine oxide, or mixtures thereof. The surfactants may be, at least in part, derived from natural sources, such as natural feedstock alcohols.

Suitable anionic surfactants may include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. The anionic surfactants may be linear, branched, or combinations thereof. Preferred surfactants include linear alkyl benzene sulfonate (LAS), alkyl ethoxylated sulfate (AES), alkyl sulfates (AS), or mixtures thereof. Other suitable anionic surfactants include branched modified alkyl benzene sulfonates (MLAS), methyl ester sulfonates (MES), sodium lauryl sulfate (SLS), sodium lauryl ether sulfate (SLES), and/or alkyl ethoxylated carboxylates (AEC). The anionic surfactants may be present in acid form, salt form, or mixtures thereof. The anionic surfactants may be neutralized, in part or in whole, for example, by an alkali metal (e.g., sodium) or an amine (e.g., monoethanolamine). Due to the presence of cationic ester quat material, it may be desirable to limit the amount of anionic surfactant so as to avoid undesirable interactions of the materials; for example, the compositions may comprise less than 5%, preferably less than 3%, more preferably less than 1%, even more preferably less than 0.1%, by weight of the composition, of anionic surfactant.

The surfactant system may include nonionic surfactant. Suitable nonionic surfactants include alkoxylated fatty alcohols, such as ethoxylated fatty alcohols. Other suitable nonionic surfactants include alkoxylated alkyl phenols, alkyl phenol condensates, mid-chain branched alcohols, mid-chain branched alkyl alkoxylates, alkylpolysaccharides (e.g., alkylpolyglycosides), polyhydroxy fatty acid amides, ether capped poly(oxyalkylated) alcohol surfactants, and mixtures thereof. The alkoxylate units may be ethyleneoxy units, propyleneoxy units, or mixtures thereof. The nonionic surfactants may be linear, branched (e.g., mid-chain branched), or a combination thereof. Specific nonionic surfactants may include alcohols having an average of from about 12 to about 16 carbons, and an average of from about 3 to about 9 ethoxy groups, such as C12-C14 EO7 nonionic surfactant.

Suitable zwitterionic surfactants may include any conventional zwitterionic surfactant, such as betaines, including alkyl dimethyl betaine and cocodimethyl amidopropyl betaine, C₈ to C₁₈ (for example from C₁₂ to C₁₈)amine oxides (e.g., C₁₂₋₁₄ dimethyl amine oxide), and/or sulfo and hydroxy betaines, such as N-alkyl-N,N-dimethylammino-1-propane sulfonate where the alkyl group can be C₈ to C₁₈, or from C₁₀ to C₁₄. The zwitterionic surfactant may include amine oxide.

Depending on the formulation and/or the intended end-use, the composition may be substantially free of certain surfactants. For example, liquid fabric enhancer compositions, such as fabric softeners, may be substantially free of anionic surfactant, as such surfactants may negatively interact with cationic ingredients.

### B. Conditioning Active

The compositions of the present disclosure may include a conditioning active. Compositions that contain conditioning actives may provide softness, anti-wrinkle, anti-static, conditioning, anti-stretch, color, and/or appearance benefits.

Conditioning actives may be present at a level of from about 1% to about 99%, by weight of the composition. The composition may include from about 1%, or from about 2%, or from about 3%, to about 99%, or to about 75%, or to about 50%, or to about 40%, or to about 35%, or to about 30%, or to about 25%, or to about 20%, or to about 15%, or to about 10%, by weight of the composition, of conditioning active. The composition may include from about 5% to about 30%, by weight of the composition, of conditioning active.

Conditioning actives suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof. Preferably the composition is a fabric care composition where the one or more adjunct ingredients comprises quaternary ammonium ester material; such materials are particularly useful in fabric enhancing/conditioning/softening compositions.

The composition may include a quaternary ammonium ester compound, a silicone, or combinations thereof, preferably a combination. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1.

The composition may contain mixtures of different types of conditioning actives. The compositions of the present disclosure may contain a certain conditioning active but be substantially free of others. For example, the composition may be free of quaternary ammonium ester compounds, silicones, or both. The composition may comprise quaternary ammonium ester compounds but be substantially free of silicone. The composition may comprise silicone but be substantially free of quaternary ammonium ester compounds.

### C. Deposition Aid

The compositions of the present disclosure may comprise a deposition aid. As described above, due to the synergistic benefits that flow from the ester quat material and the delivery particles of the present disclosure, relatively less (or even none) of a deposition aid may be required to provide comparable or even improved performance; alternatively, a deposition aid may be used in compositions of the present disclosure to boost performance even more.

Deposition aids can facilitate deposition of delivery particles, conditioning actives, perfumes, or combinations thereof, improving the performance benefits of the compositions and/or allowing for more efficient formulation of such benefit agents. The composition may comprise, by weight of the composition, from 0.0001% to 3%, preferably from 0.0005% to 2%, more preferably from 0.001% to 1%, or from about 0.01% to about 0.5%, or from about 0.05% to about 0.3%, of a deposition aid. The deposition aid may be a cationic or amphoteric polymer, preferably a cationic polymer.

Cationic polymers in general and their methods of manufacture are known in the literature. Suitable cationic polymers may include quaternary ammonium polymers known the “Polyquaternium” polymers, as designated by the International Nomenclature for Cosmetic Ingredients, such as Polyquaternium-6 (poly(diallyldimethylammonium chloride), Polyquaternium-7 (copolymer of acrylamide and diallyldimethylammonium chloride), Polyquaternium-10 (quaternized hydroxyethyl cellulose), Polyquaternium-22 (copolymer of acrylic acid and diallyldimethylammonium chloride), and the like.

The deposition aid may be selected from the group consisting of polyvinylformamide, partially hydroxylated polyvinylformamide, polyvinylamine, polyethylene imine, ethoxylated polyethylene imine, polyvinylalcohol, polyacrylates, and combinations thereof. The cationic polymer may comprise a cationic acrylate.

Deposition aids can be added concomitantly with delivery particles (at the same time with, e.g., encapsulated benefit agents) or directly/independently in the consumer product composition. The weight-average molecular weight of the polymer may be from 500 to 5000000 or from 1000 to 2000000 or from 2500 to 1500000 Dalton, as determined by size exclusion chromatography relative to polyethyleneoxide standards using Refractive Index (RI) detection. The weight-average molecular weight of the cationic polymer may be from 5000 to 37500 Dalton.

### D. Rheology Modifier/Structurant

The compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as the delivery particles as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C₁-C₃₀ alkyl ester of the (meth)acrylic acid. Such copolymers are available from Noveon Inc under the tradename Carbopol Aqua 30. Cross-linked polymers, such as cross-linked polyacrylate and/or polymers and/or co-polymers, such as those that further include nonionic monomers such as acrylamide or methacrylamide monomers, may be useful as structurants. Another suitable structurant is sold under the tradename Rheovis CDE, available from BASF.

### E. Other Adjuncts

The compositions of the present disclosure may contain other adjuncts that are suitable for inclusion in the product and/or for final usage. For example, the compositions may comprise neat perfume, perfume delivery technologies (such as pro-perfumes and/or encapsulates having non-polyisocyanate/plant-based flour wall materials), cationic surfactants, cationic polymers, solvents, suds suppressors, or combinations thereof.

### Method of Making Compositions

The present disclosure further relates to methods for making a composition of delivery particles, including combinations with such delivery particles forming various compositions including compositions such as consumer product compositions, industrial compositions, coating compositions, agricultural compositions. These are further described herein.

The method may comprise the steps of combining the population of delivery particles to form various formulations and other compositions. The population of delivery particles may preferably be provided as an aqueous slurry. The formed compositions can be in the form of a liquid composition, a powder or a dried coating.

The delivery particles may be combined with the one or more adjunct ingredients when the delivery particles are in one or more forms, including a slurry form, neat particle form, and/or spray dried particle form, preferably slurry form. The delivery particles may be combined with such adjuncts by methods that include mixing and/or spraying.

The compositions of the present disclosure can be formulated into any suitable form and prepared by any process chosen by the formulator. The one or more adjunct ingredients and the delivery particles may be combined in a batch process, in a circulation loop process, and/or by an in-line mixing process. Suitable equipment for use in the processes disclosed herein may include continuous stirred tank reactors, homogenizers, turbine agitators, recirculating pumps, paddle mixers, high shear mixers, static mixers, plough shear mixers, ribbon blenders, vertical axis granulators and drum mixers, both in batch and, where available, in continuous process configurations, spray dryers, and extruders.

### Test Methods

It is understood that the test methods disclosed in the Test Methods section of the present application should be used to determine the respective values of the parameters of Applicant's claimed subject matter as claimed and described herein.

### Viscosity

Viscosity of liquid finished product is measured using an AR 550 rheometer/viscometer from TA instruments (New Castle, DE, USA), using parallel steel plates of 40 mm diameter and a gap size of 500 μm. The high shear viscosity at 20 s⁻¹ and low shear viscosity at 0.05 s⁻¹ is obtained from a logarithmic shear rate sweep from 0.01 s⁻¹ to 25 s⁻¹ in 3 minutes time at 21° C.

### Volume-Weighted Particle Size and Size Distribution

The volume-weighted particle size distribution is determined via single-particle optical sensing (SPOS), also called optical particle counting (OPC), using the AccuSizer 780 AD instrument and the accompanying software CW788 version 1.82 (Particle Sizing Systems, Santa Barbara, California, U.S.A.), or equivalent. The instrument is configured with the following conditions and selections: Flow Rate=1 ml/sec; Lower Size Threshold=0.50 μm; Sensor Model Number=Sensor Model Number=LE400-05 or equivalent; Autodilution=On; Collection time=60 sec; Number channels=512; Vessel fluid volume=50 ml; Max coincidence=9200. The measurement is initiated by putting the sensor into a cold state by flushing with water until background counts are less than 100. A sample of delivery capsules in suspension is introduced, and its density of capsules adjusted with DI water as necessary via autodilution to result in capsule counts of at least 9200 per ml. During a time period of 60 seconds the suspension is analyzed. The resulting volume-weighted PSD data are plotted and recorded, and the values of the desired volume-weighted particle size (e.g., the median/50th percentile, 5th percentile, and/or 90th percentile) are determined.

### Procedure for Determination of % Degradation

To determine % degradation, the procedure set forth in the “OECD Guideline for Testing of Chemicals” 301B CO2 Evolution (Modified Sturm Test), adopted 17 Jul. 1992, is used. For ease of reference, this test method is referred to herein as test method OECD 301B.

### EXAMPLES

The examples provided below are intended to be illustrative in nature and are not intended to be limiting.

In the following examples, the abbreviations correspond to the materials listed in Table 1.

TABLE 1

| Trade Name | Company/City | Material |
|---|---|---|
| Soybean Flour | Sigma-Aldrich, | Emulsifier |
| | St. Louis, MO | |
| Desmodur N 3200 A | Covestro, | Aliphatic polyisocyanate |
| | Pittsburgh, PA | prepolymer |
| Mondur MR Light | Covestro, | Aromatic polymeric isocyanate |
| | Pittsburgh, PA | based on diphenylmethane- |
| | | diisocyanate |

### Example 1 (Soybean Flour)

A water phase is prepared by dispersing 40.80 g of soybean flour into 243.66 g of water while mixing with a 4-tip mixing blade at a speed of 1100 rpm in a stainless-steel reactor at a temperature of 19 C. This is allowed to mix until the soybean flour is completely dissolved into the water (at least 5 minutes of mixing time). The pH of the water phase is then adjusted to a pH of 9 using caustic soda. The isocyanates of 3.21 g of Desmodur N 3200 A and 2.36 g of Mondur MR light are mixed with the core material in a glass beaker on a stir plate for at least 5 minutes. The core material is then added to the water phase in the jacketed reactor by pouring slowly (over a 60-90 second time span). Once the oil phase is added the speed of the 4-tip milling blade is increased to 5000 rpm for milling. Milling occurs over a 45-minute time period, taking sizes every 15 minutes using the Accusizer. After 45 minutes of milling the 4-tip milling blade is replaced with a 3-inch propeller blade mixing at a speed of 300 rpm. The final pH of the slurry is taken and adjusted to 8.24 with caustic soda. The slurry is then heated from 19 C to 80° C. over 60 minutes, held at 80° C. for 480 minutes (8 hours), then cooled back to 25° C. over 60 minutes.

### Example 2 (Chickpea Flour, Lentil Flour, Yellow Pea Flour)

A water phase is prepared by dispersing 40.80 g of either Chickpea, Lentil or Yellow Pea flour into 243.66 g of water while mixing with a 4-tip mixing blade at a speed of 1100 rpm in a stainless-steel reactor at a temperature of 19° C. This is allowed to mix until the dispersed flour is completely dissolved into the water (at least 5 minutes of mixing time). The pH of the water phase is then adjusted to a pH of 9 using caustic soda. The isocyanates of 3.21 g of Desmodur N 3200 A and 2.36 g of Mondur MR light are mixed with the core material in a glass beaker on a stir plate for at least 5 minutes. The core material is then added to the water phase in the jacketed reactor by pouring slowly (over a 60-90 second time span). Once the oil phase is added the speed of the 4-tip milling blade is increased to 5000 rpm for milling. Milling occurs over a 45-minute time period, taking sizes every 15 minutes using the Accusizer. After 45 minutes of milling the 4-tip milling blade is replaced with a 3-inch propeller blade mixing at a speed of 300 rpm. The final pH of the slurry is taken and adjusted to 8.24 with caustic soda. The slurry is then heated from 19° C. to 80° C. over 60 minutes, held at 80° C. for 480 minutes (8 hours), then cooled back to 25° C. over 60 minutes.

### Example 3 (Sorghum Flour, Rice Flour)

A water phase is prepared by dispersing 40.80 g of either Sorghum or Rice Flour into 243.66 g of water while mixing with a 4-tip mixing blade at a speed of 1100 rpm in a stainless-steel reactor at a temperature of 19 C. This is allowed to mix until the dispersed flour is completely dissolved into the water (at least 5 minutes of mixing time). The pH of the water phase is then adjusted to a pH of 9 using caustic soda. The isocyanates of 3.21 g of Desmodur N 3200 A and 2.36 g of Mondur MR light are mixed with the core material in a glass beaker on a stir plate for at least 5 minutes. The core material is then added to the water phase in the jacketed reactor by pouring slowly (over a 60-90 second time span). Once the oil phase is added the speed of the 4-tip milling blade is increased to 5000 rpm for milling. Milling occurs over a 45-minute time period, taking sizes every 15 minutes using the Accusizer. After 45 minutes of milling the 4-tip milling blade is replaced with a 3-inch propeller blade mixing at a speed of 300 rpm. The final pH of the slurry is taken and adjusted to 8.24 with caustic soda. The slurry is then heated from 19° C. to 80° C. over 60 minutes, held at 80° C. for 480 minutes (8 hours), then cooled back to 25° C. over 60 minutes.

To compare the performance of delivery particles made with the plant-based flours of the invention with refined protein material of different sources, or different molecular weights, comparative samples are prepared with the different delivery particles.

### Comparative Example 4 (Soy Protein)

Table 2 shows the general formula according to the invention.

TABLE 2

| Trade Name | Company/City | Material |
|---|---|---|
| Soy Protein Acid | Sigma | Emulsifier |
| Hydrolysate | | |
| Desmodur N 3200 A | Covestro | Aliphatic polyisocyanate |
| | | prepolymer |
| Mondur MR Light | Covestro | Aromatic isocyanate based |
| | | on diphenylmethane- |
| | | diisocyanate |

A water phase is prepared by dispersing 28.34 g of soy protein acid hydrolysate into 293.66 g of water while mixing with a 4-tip mixing blade at a speed of 1000 rpm in a stainless-steel reactor at a temperature of 20 C. This is allowed to mix until the dispersed protein is completely dissolved into the water (at least 5 minutes of mixing time). The pH of the water phase was not adjusted. The isocyanates of 1.33 g of Desmodur N 3200 A and 0.65 g of Mondur MR light are mixed with the core material in a glass beaker on a stir plate for at least 5 minutes. The core material is then added to the water phase in the jacketed reactor by pouring slowly (over a 60-90 second time span). Once the oil phase is added the speed of the 4-tip milling blade is increased to 4000 rpm for milling. Milling occurs over a 45-minute time period, taking sizes every 15 minutes using the Accusizer. After 45 minutes of milling the 4-tip milling blade is replaced with a 3-inch propeller blade mixing at a speed of 300 rpm. The slurry is then heated from 20° C. to 65° C. over 60 minutes, held at 65° C. for 480 minutes (8 hours), then cooled back to 25° C. over 60 minutes.

### Example 5

TABLE 3

| | | | Structural | | | | |
|---|---|---|---|---|---|---|---|
| | Protein | N Content | Polysacharride | Starch | Glycoprotein | D50 | D90 |
| | (Wt %) | % | (Wt %) | (Wt %) | (Y/N) | (μ) | (μ) |
| Soybean Flour | >45 | 8.64 | 15-25 | <5 | Y | 7.28 | 11.82 |
| Chickpea Flour | 22-29 | 4.08 | 12-18 | 30-40 | Y | 12.32 | 26.37 |
| Lentil Flour | 22-28 | 4 | 8-12 | 40-50 | Y | 10.34 | 24.58 |
| Yellow Pea | 14-20 | 2.72 | 14-20 | 35-45 | Y | 9.79 | 26.05 |
| Flour | | | | | | | |
| Sorghum Flour | 8-14 | 1.76 | 3-10 | 65-75 | Y | 14.48 | 28.25 |
| Rice Flour | 4-8 | 0.96 | 2-5 | 75-85 | Y | 51.48 | 78.18 |
| Hydrolyzed | Approx. 100% | 16 | Approximately | 0 | N | 116.07 | 182.64 |
| Soy Protein | | | 0% | | | | |

Table 3 shows that soy flour has favorable D50 and D90 values. N Content refers to nitrogen content of the plant-based flour. The Glycoprotein column indicates presence or absence of glycoprotein. As Table 3 shows, soybean has low D50 and D90 values. Chickpea, lentil, and yellow pea similarly have low D50 values but elevated D90 values suggesting less emulsion stability and more droplet coalescence. Sorghum and rice flours have large D50 (at least 2× that of soy) and elevated D90 values. D50 and 90 are statistical parameters relating to the cumulative particle size distribution. The indicated values reflect the size below which 50% or 90% of all particles are found.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A population of delivery particles,
wherein the delivery particles comprise a core and shell surrounding the core,
wherein the core comprises a benefit agent,
wherein the shell comprises a polymeric material that is the reaction product of isocyanate and a plant-based flour, and optionally, from 0 to 5% by weight of an emulsifier,
wherein the plant-based flour is characterized by:
a) a protein content, of at least 15% by weight of the flour,
b) a structural polysaccharide content of at least 10% by weight of the flour,
c) a starch content of less than 50% by weight of the flour, and,
d) a portion of the protein comprising at least one glycoprotein.

2. The population of delivery particles according to claim 1 wherein the plant-based flour comprises a nitrogen content of from 2.5 to 10% by weight.

3. The population of delivery particles according to claim 1, wherein the shell comprises internal and external surfaces, the internal surface of the shell comprising the isocyanate and the external surface of the shell comprising the plant-based flour, the plant-based flour having amine moieties and/or hydroxyl moieties cross-linked with the isocyanate of the internal surface thereby forming the polymeric material of the shell.

4. The population of delivery particles according to claim 1, wherein the plant-based flour is characterized by a structural carbohydrate molecular weight of from about 5000 kDa to about 35,000 kDa,

5. The population of delivery particles according to claim 1, wherein the plant-based flour is characterized by being comprised of structural carbohydrates comprising arabinogalactan polysaccharide consisting of arabinose and galactose units in the ratio of 1:0.3 to 1:3 by weight, and uronic acid polysaccharide comprising less than 50%, preferably less than 30% uronic acid, by weight of the plant based flour.

6. The population of delivery particles according to claim 1, wherein the plant-based flour is characterized by comprising at least 47% protein and at least 47% carbohydrate/starch/saccharide, and wherein the plant-based flour is characterized by comprising 5% or less % by weight of uronic acid.

7. The population of delivery particles according to claim 1, wherein the isocyanate comprises a monomer, oligomer, prepolymer or polymer selected from the group consisting of a polyisocyanurate of toluene diisocyanate, a trimethylol propane adduct of toluene diisocyanate, a trimethylol propane adduct of xylylene diisocyanate, methylene diphenyl isocyanate, toluene diisocyanate, tetramethylxylidene diisocyanate, naphthalene-1,5-diisocyanate, phenylene diisocyanate and combinations thereof.

8. The population of delivery particles according to claim 1, wherein the reaction product is formed in a reaction, wherein the weight ratio of the soy flour present in the reaction to the isocyanate present in the reaction is from about 1:10 to about 1:0.1.

9. The population of delivery particles according to claim 1, wherein the benefit agent is a fragrance material.

10. The population of delivery particles according to claim 1, wherein the core further comprises a partitioning modifier, optionally present in the core at a level of from about 5% to about 55%, preferably from about 10% to about 50%, more preferably from about 25% to about 50%, by weight of the core,
preferably a partitioning modifier selected from the group consisting of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof,
more preferably isopropyl myristate.

11. The population of delivery particles according to claim 1, wherein the delivery particles are characterized by a volume-weighted median particle size from about 1 to about 100 microns,
preferably from about 1 to about 50 microns, or even preferably from about 1 to about 25 microns,
more preferably from about 1 to about 10 microns.

12. The population of delivery particles according to claim 1, wherein the delivery particles are obtainable from a process comprising the steps of:
forming a water phase by dissolving or dispersing a soy flour in water,
forming an oil phase comprising dissolving together at least one benefit agent and at least one isocyanate, optionally with an added oil and a partitioning modifier.
forming an emulsion by mixing under high shear agitation the water phase and the oil phase into an excess of the water phase, thereby forming droplets of the benefit agent and optional added oil dispersed in the water phase, and optionally adjusting the pH of the emulsion to be in a range from pH 5 to 12.
curing the emulsion by heating to at least 40° C., for a time sufficient to form a shell at an interface of the droplets with the water phase, the shell comprising the reaction product of the plant-based flour with the isocyanate, the shell surrounding the core comprising the droplets of the benefit agent and optional added oil.

13. The population of delivery particles according to claim 1, wherein the shells of the delivery particles degrade at least 60% in 28 days when tested according to test method OECD 301B.

14. The population of delivery particles according to claim 12, wherein the population of delivery particles are provided as an aqueous slurry.

15. An article of manufacture incorporating the population of delivery particles according to claim 1.

16. The article of manufacture according to claim 15 wherein the article is selected from the group consisting of a soap, a surface cleaner, a laundry detergent, a fabric softener, a shampoo, a textile, a paper towel, an adhesive, a wipe, a diaper, a feminine hygiene product, a facial tissue, a pharmaceutical, a napkin, a deodorant, a heat sink, a foam, a pillow, a mattress, bedding, a cushion, a cosmetic, a medical device, packaging, an agricultural product, a cooling fluid, a wallboard, and an insulation.
